(19) United States
(12) Patent Application Publication
(10) Pub. No.: US 2003/0236650 A1
(43) Pub. Date: Dec. 25, 2003

(54) Client-side data analysis program, server-side data analysis program, and associated-communication-interface generation program

(75) Inventors: Koichi Miura, Kawasaki (JP); Kazuo Imada, Kawasaki (JP); Yoshitaka Honishi, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/464,313

(22) Filed: Jun. 18, 2003

(30) Foreign Application Priority Data
Jun. 25, 2002 (JP) 2002-183864

(51) Int. Cl. G06F 15/00

(52) U.S. Cl. 702/188

(57) ABSTRACT

A client-side data analysis program, a server-side data analysis program, and an associated-communication-interface generation program which can early detect a computer using an interface which has not yet been changed, and prevent occurrence of an unexpected situation. A data analysis unit in a client generates and transmits processing-request data containing first identification information acquired from an application-identifier management file, when the first identification information coincides with second identification information held in association with a predefined data structure. A data analysis unit in a server analyzes a data structure of processing-request data based on a predefined data structure when first identification information acquired from an application-identifier management file and contained in the processing-request data coincides with second identification information held in association with the predefined data structure.

### BACKGROUND OF THE INVENTION

1) Field of the Invention

The present invention relates to a client-side data analysis program, a server-side data analysis program, and an associated-communication-interface generation program for performing communication through a network. In particular, the present invention relates to a client-side data analysis program, a server-side data analysis program, and an associated-communication-interface generation program for performing communication by data having a unified data structure.

2) Description of the Related Art

With the recent development of the client-server type systems, associated systems of client and server applications have been proposed. In the associated systems of client and server applications, a client application requests a server application to perform processing, and the server application returns a processing result to the client application. According to the associated systems of client and server applications, it is possible to generalize interfaces of server applications, and develop client and server applications independently of development languages. In interfaces of server applications, data structures including names of processing, parameters received by the processing, and the like can be defined in an abstract language. The parameters include: information indicating “only reception,” “only delivery,” or “both of reception and delivery”; the number of parameters; the data format (e.g., integer, floating point, character string, binary data, structure, array); and the like.

In order to efficiently transfer data having various formats between clients and servers, communication protocols in which information including only values of data (not including data identifiers) are transferred are used. Therefore, both of the clients and servers are required to be informed of structures of delivered data in advance. Thus, the following techniques are provided.

A compiler for generating programs which enable a client application and a server application to recognize a data structure is provided. These programs are generated from descriptions defining an interface of the server application and including a definition of a data structure. Specifically, the compiler generates a client-side program called stub and a server-side program called skeleton.

In addition, the compiler registers, in a repository, information on the interface of the server application, where the information includes a definition of a structure of delivered data. Thus, the client application can analyze data based on the information in the repository.

By combining the above functions, the client application and the server application can analyze the data in the following four ways.

In the first way, the client application analyzes the data by using the program (stub) generated by the compiler, and the server application analyzes the data by using the program (skeleton) generated by the compiler.

In the second way, the client application analyzes the data by using the program (stub) generated by the compiler, and the server application analyzes the data by referring to the information on the interface registered in the repository.

In the third way, the client application analyzes the data by referring to the information on the interface registered in the repository, and the server application analyzes the data by using the program (skeleton) generated by the compiler.

In the fourth way, the client application analyzes the data by referring to the information on the interface registered in the repository, and the server application also analyzes the data by referring to the information on the interface registered in the repository.

Thus, it is possible to correctly transfer information between the server application and the client application without inserting information defining the data format in the transferred information.

However, with the increase in the sizes of network systems, the version management of the programs (stubs and skeletons) for interfacing has been becoming difficult. If a definition of a data structure of a server-side program (skeleton) is updated, and a definition of a data format of a client-side program (stub) is not updated, a difference occurs between the data formats of transferred information. When the difference occurs, it is impossible to correctly process received data. For example, if data which is transmitted as having the “integer” format is received based on a recognition that the received data has the “character string” format, an error occurs, or an erroneous processing result is outputted.

In particular, in the case where companies or vendors providing a client application and a server application are different in a client-server type system, as in intercompany association systems and heterogeneous systems, problems concerning differences between versions of interfaces are likely to occur. That is, when a company changes an interface of a server application with no notification, it is sometimes impossible to connect a server application to another application which has been connected to the server application until the change. In this case, a program for data analysis abends.

According to Japanese Unexamined Patent Publication No. 2002-14832, an attempt to increase the reliability of communication relating to unification of interfaces in a server and a client is made by holding the identification information identifying an interface in a communication means in each of the server and the client (i.e., in each of a client stub and a server stub). However, since the identification information is fixedly held in the communication means according to the technique disclosed in Japanese Unexamined Patent Application No. 2002-14832, it is easy to unauthorizedly use the interface by copying the client stub and the server stub without permission. When a duplicate of the client stub or the server stub is produced without permission, and thereafter the original interface is changed, it is difficult to find a communication means which has not yet been updated on the network.

### SUMMARY OF THE INVENTION

The present invention is made in view of the above problems, and the object of the present invention is to provide a client-side data analysis program, a server-side data analysis program, and an associated-communication-interface generation program which can detect, at an early stage of an operation of changing a data structure of an interface, a computer using an interface in which a data structure has not yet been changed, so as to prevent occurrence of an unexpected situation.

In order to accomplish the above object, a client-side data analysis program executed by a computer for performing communication by data having a unified structure between applications connected through a network is provided. The client-side data analysis program makes a computer perform a sequence of processing which comprises the steps of: (a) acquiring through a network first identification information associated with a processing application to which a processing request is to be outputted; (b) comparing the first identification information with second identification information held in association with a predefined data structure; and (c) generating data of the processing request having the predefined data structure, and transmitting the data of the processing request to a server in which the processing application is installed, when a result of comparison obtained in step (b) indicates that the first identification information coincides with second identification information.

In addition, in order to accomplish the above object, a server-side data analysis program executed by a computer for performing communication by data having a unified structure between applications connected through a network is provided. The server-side data analysis program makes the computer perform a sequence of processing which comprises the steps of: (a) acquiring first identification information contained in data of a processing request, when the data of the processing request is received from a client; (b) comparing the first identification information with second identification information held in association with a predefined data structure; and (c) analyzing a data structure of the data of the processing request based on the predefined data structure when a result of comparison obtained in step (b) indicates that the first identification information coincides with second identification information.

Further, in order to accomplish the above object, an associated-communication-interface generation program executed by a computer for generating an associated-communication interface which performs communication by data having a unified structure between applications connected through a network is provided. The associated-communication-interface generation program makes the computer perform a sequence of processing which comprises the steps of: (a) generating, based on interface information in which a data structure of transferred data is defined, a data analysis program for performing data analysis in accordance with the data structure so that the data analysis program includes identification information based on which the interface information can be uniquely identified; and (b) registering the identification information in an application-identifier management file arranged at a predetermined location on the network.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in an embodiment;

FIG. 2 is a diagram illustrating an exemplary construction of an associated-communication system as an embodiment of the present invention;

FIG. 3 is a diagram illustrating an example of a hardware construction of a data-association-information management server used in the embodiment of the present invention;

FIG. 4 is a function block diagram illustrating functions realizing the associated-communication system;

FIG. 5 is a conceptual diagram illustrating a situation in which data analysis programs are generated;

FIG. 6 is a flowchart illustrating a procedure for generation of the data analysis programs;

FIG. 7 is a diagram illustrating an example of data analysis performed by using a data analysis program (stub) in a client;

FIG. 8 is a diagram illustrating an example of data analysis performed in the client by using a repository;

FIG. 9 is a diagram illustrating an example of data analysis performed by using a data analysis unit in a server; and

FIG. 10 is a diagram illustrating an example of data analysis performed in the server by using the repository.

### DESCRIPTION OF THE PREFERRED EMBODIMENTS

An embodiment of the present invention is explained below with reference to drawings.

First, an outline of the present invention which is realized in the embodiment is explained, and thereafter details of the embodiment are explained.

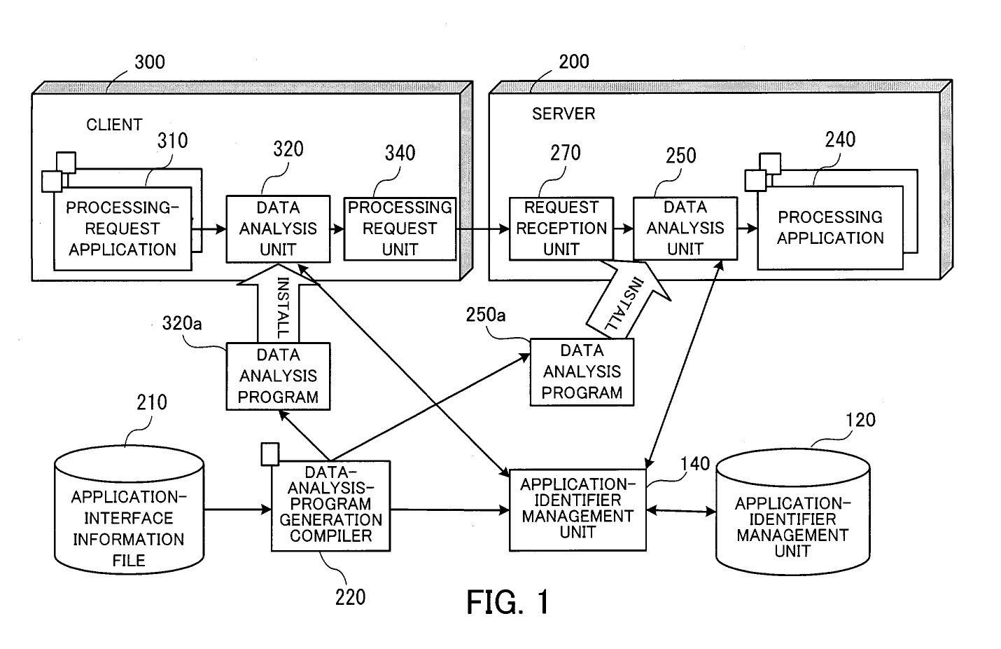

FIG. 1 is a conceptual diagram illustrating the present invention which is realized in the embodiment. In the embodiment of the present invention, a client-side data analysis program (a data analysis program 320a) and a server-side data analysis program (a data analysis program 250a) are provided so that data communication between a processing-request application 310 in a client 300 and a processing application 240 in a server 200 based on a unified structure is enabled. Each of the data analysis program 250a and the data analysis program 320a is generated by a computer which executes an associated-communication-interface generation program.

Functions of a data-analysis-program generation compiler 220 are realized on the computer executing the associated-communication-interface generation program, according to which the following processing is performed.

The data-analysis-program generation compiler 220 has functions of generating an associated-communication interface which realizes communication by data having a unified structure between applications connected through a network. That is, based on interface information defining a structure of transferred data, the data-analysis-program generation compiler first generates the data analysis program 250a and the data analysis program 320a which perform data analysis in accordance with a predetermined data structure and hold identification information. The interface information can be uniquely identified based on the identification information, and is stored, for example, in an application-interface information file 210.

The data-analysis-program generation compiler 220 registers identification information in an application-identifier management file 120 which is arranged at a predetermined location on the network. For example, the application-identifier management file 120 is managed by an application-identifier management unit 140, and the identification information from the data-analysis program generation compiler 220 is stored in the application-identifier management file 120 through the application-identifier management unit 140.

When the server 200 executes the data analysis program 250a generated as above, functions of a data analysis unit 250 are realized on the server 200. In addition, when the client 300 executes the data analysis program 320a, functions of a data analysis unit 320 are realized on the client 300. Thus, when the data analysis unit 250 and the data analysis unit 320 constructed as above operate by referring to the identification information stored in the application-identifier management file 120, associated communication by data having a unified structure is enabled between the processing-request application 310 and the processing application 240.

As illustrated in FIG. 1, the client 300 comprises the processing-request application 310 and a processing request unit 340 as well as the data analysis unit 320. The processing-request application 310 and the processing request unit 340 are processing functions which are realized when the client 300 executes a program in which details of predetermined processing are described.

When the data analysis unit 320 outputs a processing request to the processing application 240 in response to a request from the processing-request application 310, the data analysis unit 320 acquires first identification information associated with the processing application 240 through a network. In the example of FIG. 1, the first identification information is stored in the application-identifier management file 120. Next, the data analysis unit 320 compares the first identification information with second identification information which is held in association with a predefined data structure. When the comparison indicates that the first identification information coincides with the second identification information, the data analysis unit 320 generates data of the processing request (processing-request data) having the predefined data structure, and transmits the data of the processing request through the processing request unit 340 to the client 300 in which the processing application 240 is installed.

In addition, as illustrated in FIG. 1, the server 200 comprises the processing application 240 and a request reception unit 270 as well as the data analysis unit 250. The processing application 240 and the request reception unit 270 are processing functions which are realized when the server 200 executes a program in which details of predetermined processing are described.

When the data analysis unit 250 receives the data of the processing request from the client 300, the data analysis unit 250 acquires the first identification information contained in the data of the processing request. Next, the data analysis unit 250 compares the first identification information with second identification information which is held in association with a predefined data structure. When the comparison indicates that the first identification information coincides with the second identification information, the data analysis unit 250 analyzes the structure of data of the processing request based on the predefined data structure.

When associated communication as above is performed, the client 300 generates data of a processing request and transmits the data of the processing request to the server only when the first identification information acquired through the network coincides with the second identification information associated with the predefined data structure. In addition, the server 200 performs the analysis based on the predefined data structure only when the first identification information contained in the data of the processing request coincides with the second identification information associated with the predefined data structure.

Therefore, when the application-interface information 210 is changed, and a new version of the data analysis program 250a and a new version of the data analysis program 320a are generated by the data-analysis-program generation compiler 220. The first identification information does not coincide with the second identification information in each of the comparisons in the data analysis unit 250 and the data analysis unit 320 unless the data analysis unit 250 and the data analysis unit 320 are constructed based on the newly generated data analysis program 250a and data analysis program 320a. Therefore, the data analysis unit 320 cannot generate the data of the processing request unless the data analysis unit 320 is updated with the newly generated data analysis program 320a. In addition, the data analysis unit 250 cannot analyze the received data of the processing request unless the data analysis unit 250 is updated with the newly generated data analysis program 250a. Thus, it is possible to detect a difference between interfaces of applications in the client 300 and the server 200, and construct a reliable client-server type system constituted by different companies, vendors, and the like.

Although FIG. 1 shows a case where a definition of a structure of data by which communication is performed is contained in the descriptions of each of the data analysis program 250a and the data analysis program 320a which are generated by the data-analysis-program generation compiler 220, alternatively, it is possible to register interface information in a repository and perform analysis of the data structure or the like by referring to the repository. Therefore, in the system in the embodiment explained below, it is possible to perform both of the data analysis by using a program generated from a compiler and the data analysis by referring to interface information in a repository. In addition, since, in the explanations with reference to FIG. 1, the identification information is used for determining whether or not a coincidence in the interface information occurs, hereinafter the identification information is referred to as coincidence-determination information.

Hereinbelow, an embodiment of the present invention is explained in detail.

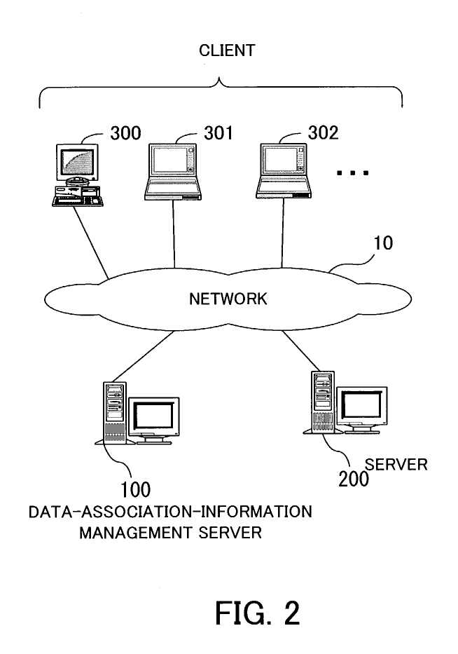

FIG. 2 is a diagram illustrating an exemplary construction of an associated-communication system as an embodiment of the present invention. In the present embodiment, a data-association-information management server 100, a server 200, and a plurality of clients 300, 301, 302, . . . are interconnected. The data-association-information management server 100 is a server computer which manages definitions of data formats, the coincidence-determination information corresponding to the interface information arranged for data association, and other information, where the definitions of data formats are analyzed by programs which are arranged for data association and installed in the server 200 and the plurality of clients 300, 301, 302, . . . . The server 200 is a computer which executes various types of data processing in response to requests from the plurality of clients 300, 301, 302 . . . . The plurality of clients 300, 301, 302, . . . are computers which request the server 200 to perform data processing in response to user's manipulation inputs and the like.

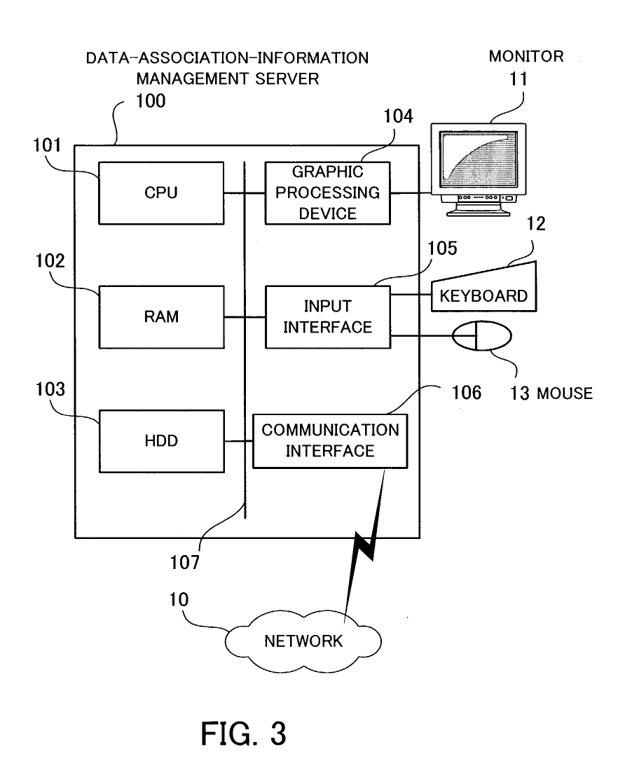

FIG. 3 is a diagram illustrating an example of a hardware construction of a data-association-information management server used in the embodiment of the present invention. The entire system of the data-association-information management server 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least portions of an OS (operating system) program and application programs which are executed by the CPU 101, as well as various types of data necessary for processing by the CPU 101. The HDD 103 stores the OS and the application programs.

A monitor 11 is connected to the graphic processing device 104, which makes the monitor 11 display an image on a screen in accordance with an instruction from the CPU 101. A keyboard 12 and a mouse 13 are connected to the input interface 105, which transmits signals sent from the keyboard 12 and the mouse 13, to the CPU 101 through the bus 107.

The communication interface 106 is connected to a network 10. The communication interface 106 is provided for exchanging data with other computers through the network 10.

By using the above hardware construction, it is possible to realize processing functions in the embodiment of the present invention. Although FIG. 3 shows a hardware construction of the data-association-information management server 100, each of the server 200 and the plurality of clients 300, 301, 302, . . . can also be realized by using a similar hardware construction.

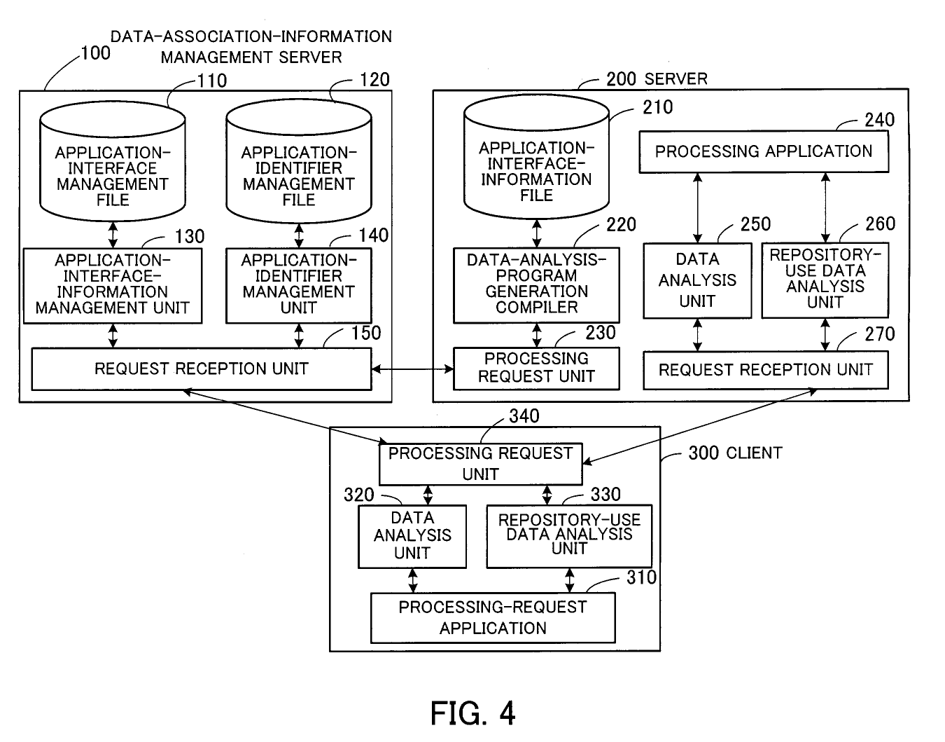

FIG. 4 is a function block diagram illustrating the functions realizing the associated-communication system.

The data-association-information management server 100 comprises an application-interface management file 110, an application-identifier management file 120, an application-interface-information management unit 130, an application-identifier management unit 140, and a request reception unit 150.

The application-interface management file 110 contains details of a definition of a structure of transferred data and coincidence-determination information for uniquely identifying the definition of the data structure. The application-interface management file 110 behaves as the aforementioned repository.

The application-identifier management file 120 contains information for managing locations of applications and the coincidence-determination information for uniquely identifying the definition of the data structure in interfaces.

The application-interface-information management unit 130 manages the information registered in the application-interface management file 110. For example, the application-interface-information management unit 130 receives a request from another computer (such as the server 200 or one of the plurality of clients 300, 301, 302, . . . ), and transmits information in the application-interface management file 110 to the computer from which the application-interface-information management unit 130 receives the request.

The application-identifier management unit 140 manages the information registered in the application-identifier management file 120. For example, the application-identifier management unit 140 receives a request from another computer (such as the server 200 or one of the plurality of clients 300, 301, 302, . . . ), and transmits information in the application-identifier management file 120 to the computer from which the application-identifier management unit 140 receives the request.

The request reception unit 150 exchanges data with another computer (such as the server 200 or one of the plurality of clients 300, 301, 302, . . . ) through the network 10.

In the server 200, an application-interface information file 210, a data-analysis-program generation compiler 220, a processing request unit 230, a processing application 240, a data analysis unit 250, a repository-use data analysis unit 260, and a request reception unit 270 are provided.

The application-interface information file 210 contains a format of data transferred between the server 200 and the plurality of clients 300, 301, 302, . . . , and other information. For example, the application-interface information file 210 is a file called IDL (Interface Definition Language) file.

The data-analysis-program generation compiler 220 is a compiler for generating a data analysis program 250a, a data analysis program 320a, and the like which can analyze the data structure of information transferred between the server 200 and the plurality of clients 300, 301, 302, . . . .

The processing request unit 230 outputs to the data-association-information management server 100 and the like a request for registration of information on an application interface (application-interface information), and the like.

The processing application 240 executes processing in response to a request from the client 300. Specifically, the processing application 240 receives a processing request from the client 300 through the data analysis unit 250 or the repository-use data analysis unit 260. The processing application 240 executes processing in accordance with received data. In addition, the processing application 240 passes a processing result to the data analysis unit 250 or the repository-use data analysis unit 260.

The data analysis unit 250 analyzes data such as a processing request sent from the client 300, in accordance with information defining a data structure which is preset. Then, the data analysis unit 250 passes to the processing application 240 data such as the processing request after the structure of the data is analyzed.

The repository-use data analysis unit 260 analyzes data such as a processing request sent from the client 300, in accordance with information defining a data structure which is set in the application-interface management file 110. Then, the repository-use data analysis unit 260 passes to the processing application 240 data such as the processing request after the structure of the data is analyzed.

The request reception unit 270 passes data such as a processing request sent from the client 300, to the data analysis unit 250 or the repository-use data analysis unit 260. In addition, when the request reception unit 270 receives a processing result from the data analysis unit 250 or the repository-use data analysis unit 260, the request reception unit 270 transmits the processing result to the client 300.

The client 300 comprises a processing-request application 310, a data analysis unit 320, a repository-use data analysis unit 330, and a processing request unit 340.

The processing-request application 310 passes a processing request to the data analysis unit 320 or the repository-use data analysis unit 330 in response to a user's manipulation input or the like. In addition, when the processing-request application 310 receives data representing the processing result from the data analysis unit 320 or the repository-use data analysis unit 330, the processing-request application 310 displays the data on the screen of the monitor or the like.

The data analysis unit 320 generates data of processing-request data having a predetermined data structure, from the processing request received from a processing-request application 310, in accordance with information defining a data structure which is preset. Then, the data analysis unit 320 passes the generated processing-request data to the processing request unit 340.

The repository-use data analysis unit 330 generates processing-request data having a predetermined data structure, from a processing request received from the processing-request application 310, in accordance with information defining a data structure which is set in the application-interface management file 110. Then, the repository-use data analysis unit 330 passes the generated processing-request data to the processing request unit 340.

The processing request unit 340 transmits to the data-association-information management server 100 data such as the processing-request data received through the data analysis unit 320 or the repository-use data analysis unit 330. In addition, when the processing request unit 340 receives data of a processing result from the server 200, the processing request unit 340 passes the data to the data analysis unit 320 or the repository-use data analysis unit 330.

In the system having the above construction, first, the data-analysis-program generation compiler 220 generates data analysis programs.

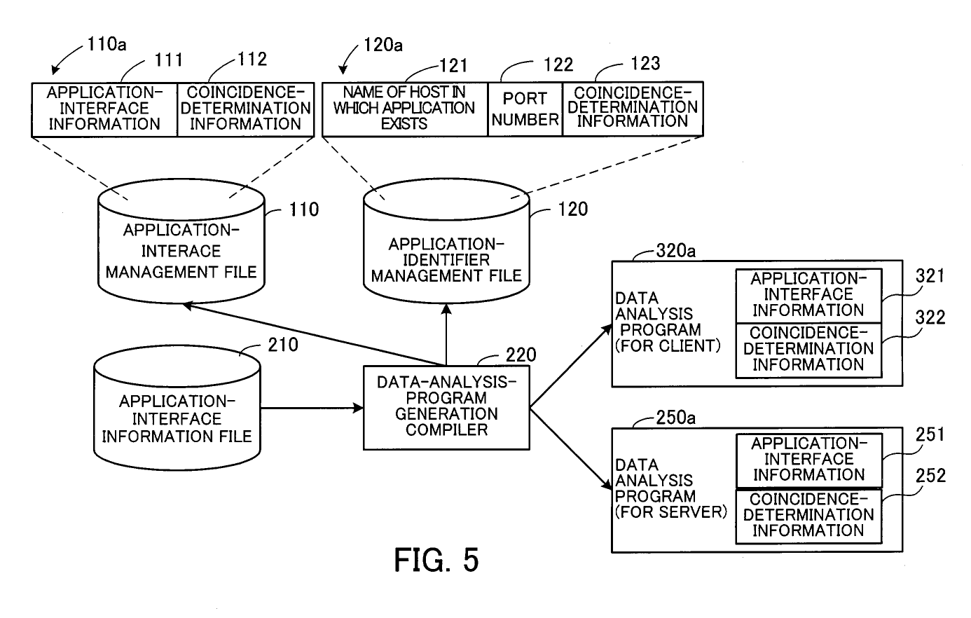

FIG. 5 is a conceptual diagram illustrating a situation in which the data analysis programs are generated. The data analysis programs 320a and 250a are generated by the data-analysis-program generation compiler 220. Specifically, the data-analysis-program generation compiler 220 refers to the application-interface information file 210, and generates the data analysis programs 320a and 250a which analyze information having a data format defined in the application-interface information file 210.

The data analysis programs 320a and 250a are files having a form which enables execution by a computer, where the data analysis program 320a is generated for the client 300, and the data analysis program 250a is generated for the server 200.

In the data analysis program 320a for the client, application-interface information 321 and coincidence-determination information 322 are embedded. The application-interface information 321 is identification information for uniquely identifying the application-interface information file 210 based on which the data analysis program 320a is generated. The coincidence-determination information 322 is information defining a data structure and the like of information to be analyzed by the data analysis program 320a.

Similarly, in the data analysis program 250a for the server 200, application-interface information 251 and coincidence-determination information 252 are embedded. The details of the application-interface information 251 and the coincidence-determination information 252 are identical to the application-interface information 321 and the coincidence-determination information 322, respectively.

When the data-analysis-program generation compiler 220 generates the data analysis programs 320a and 250a, the data-analysis-program generation compiler 220 stores in the application-interface management file 110 interface management information 110a containing application-interface information 111 and coincidence-determination information 112. The application-interface information 111 is identical to the application-interface information 321 and 251 embedded in the data analysis programs 320a and 250a. In addition, the coincidence-determination information 112 is identical to the coincidence-determination information 322 and 252 embedded in the data analysis programs 320a and 250a.

Further, when the data-analysis-program generation compiler 220 generates the data analysis programs 320a and 250a, the data-analysis-program generation compiler 220 stores in the application-identifier management file 120 identifier information 120a containing a host name 121 of a host in which an application exists, a port number 122, and coincidence-determination information 123. The host name 121 of the host at which the application exists is a name (such as a domain name) defined on the network 10 for the server 200 in which the processing application 240 is installed. The port number 122 is an identification number associated with the processing application 240 in the server 200. The coincidence-determination information 123 is identical to the coincidence-determination information 322 and 252 embedded in the data analysis programs 320a and 250a.

When the data analysis program 320a generated for the client is installed in the client 300, the data analysis unit 320 is constructed in the client 300. In addition, when the data analysis program 250a is installed in the server 200, the data analysis unit 250 is constructed in the server 200.

Hereinbelow, an example of a procedure for generation of the data analysis programs is explained.

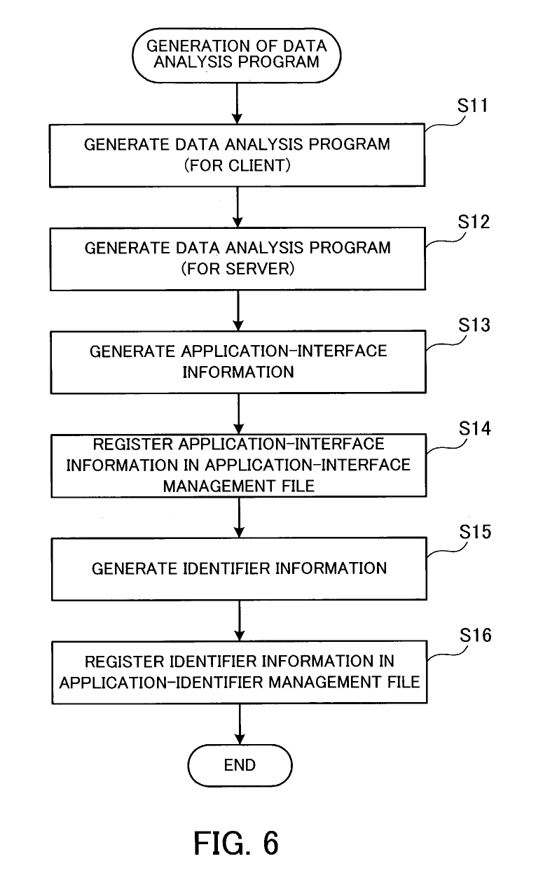

FIG. 6 is a flowchart illustrating a procedure for generation of the data analysis programs. The processing illustrated in FIG. 6 is explained below step by step.

[Step S11] The data-analysis-program generation compiler 220 generates the data analysis program 320a for the client.

[S12] The data-analysis-program generation compiler 220 generates the data-analysis-program 250a for the server 200.

[Step S13] The data-analysis-program generation compiler 220 generates the application-interface information 111.

[Step S14] The data-analysis-program generation compiler 220 registers the application-interface information 111 in the application-interface management file 110.

[Step S15] The data-analysis-program generation compiler 220 generates the identifier information 120a.

[Step S16] The data-analysis-program generation compiler 220 registers the generated identifier information 120a in the application-identifier management file 120.

The processing for generation of the data analysis programs is performed every time the contents of the application-interface information file 210 are changed (e.g., details of a definition of data are changed). When new data analysis programs are generated, a new data analysis program 250a is installed in the server 200, and the data analysis unit 250 is updated. At this time, it is necessary to install a new data analysis program 320a in all clients in which an old data analysis program 320a has been installed. However, when the number of the clients is very great, the data analysis program 320a may not be updated in some clients. Therefore, when the processing-request application 310 outputs a processing request to the processing application 240 in the server 200, it is determined whether or not a coincidence with a definition of a data structure occurs, based on the coincidence-determination information.

The determination as to whether or not a coincidence with a definition of a data structure occurs is made during an analysis of transferred data. The data is analyzed in two ways. In the first way, the data analysis units 320 and 250 analyze the data. In the second way, the repository-use data analysis units 330 and 260 analyze the data by referring to the interface information in the repository (the application-interface management file 110). Hereinbelow, details of processing in each of the first and second ways are explained.

First, the data analysis performed by using the data analysis program (stub) in the client 300 is explained.

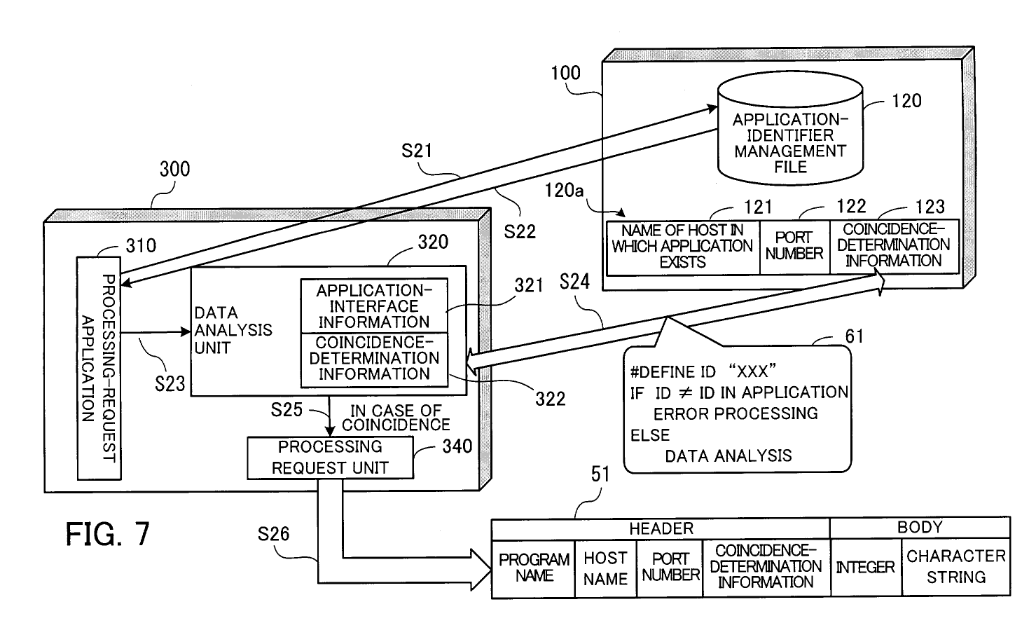

FIG. 7 is a diagram illustrating an example of the data analysis performed by using the data analysis program (stub) in the client. When the processing-request application 310 in the client 300 calls the processing application 240 in the server 200, first, the client 300 accesses the application-identifier management file 120 (in step S21), and acquires the identifier information 120a for the processing application 240 from the application-identifier management file 120 (in step S22). Then, the acquired identifier information 120a is passed to the data analysis unit 320 (in step S23).

The data analysis unit 320 compares the coincidence-determination information 322 installed in the data analysis unit 320, with the coincidence-determination information 123 included in the identifier information 120a for the processing application 240. When a noncoincidence is detected by the comparison, error processing is performed. When a coincidence is detected by the comparison, the data analysis is started (in step S24).

The processing performed by the data analysis unit 320 for determination as to whether or not a coincidence occurs can be expressed by, for example, the statements 61 illustrated in FIG. 7. That is, the coincidence-determination information installed in the data analysis unit 320 is set in “ID” (#define ID “XXX”), and the “ID” is compared with the coincidence-determination information 123 acquired from the application-identifier management file 120. When a noncoincidence is detected by the comparison (If ID≠ID Application), error processing is performed. When a coincidence is detected by the comparison (Else), the data analysis is performed.

The processing-request data analyzed by the data analysis unit 320 is passed to the processing request unit 340 (in step S25). Then, the processing request unit 340 transmits the processing-request data 51 to the server 200 (in step S26). The processing-request data 51 is constituted by, for example, a header and a body. The header contains a program name, a host name, a port number, and coincidence-determination information, and the body contains an integer value and a character string.

Next, the data analysis performed in the client by using the repository (the application-interface management file 110) is explained.

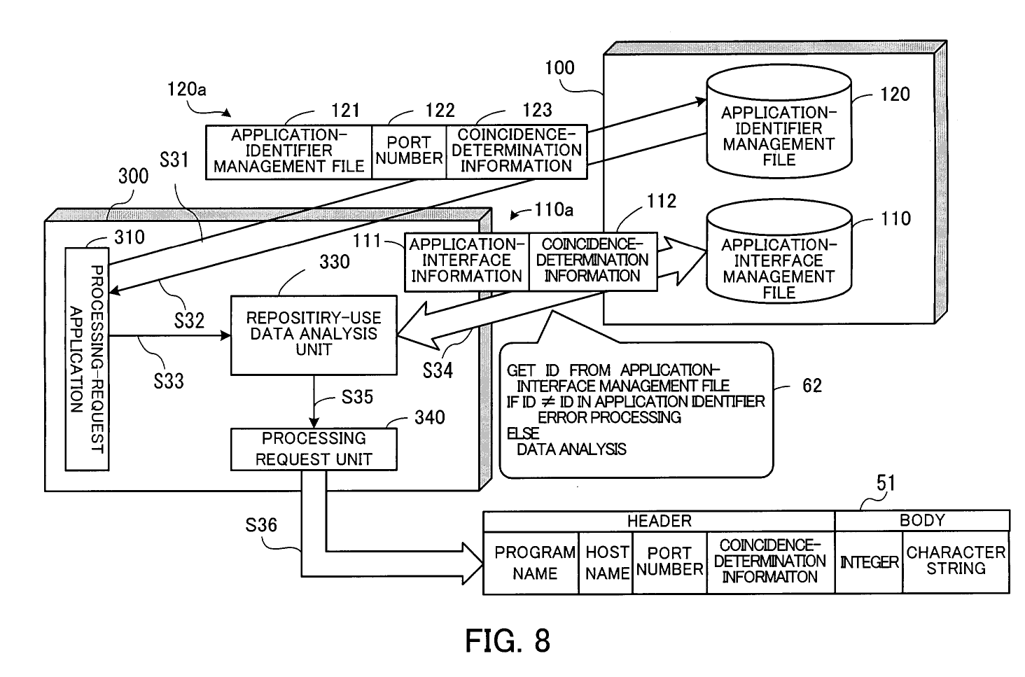

FIG. 8 is a diagram illustrating an example of the data analysis performed in the client by using the repository. When the processing-request application 310 in the client 300 calls the processing application 240 in the server 200, first, the processing-request application 310 accesses the application-identifier management file 120 (in step S31), and acquires the identifier information 120a for the processing application 240 from the application-identifier management file 120 (in step S32). Then, the acquired identifier information 120a is passed to the repository-use data analysis unit 330 (in step S33).

The repository-use data analysis unit 330 compares the coincidence-determination information 112 stored in the application-interface management file 110 for the processing application 240, with the coincidence-determination information 123 included in the identifier information 120a for the processing application 240. When a noncoincidence is detected by the comparison, error processing is performed. When a coincidence is detected by the comparison, the data analysis is started (in step S34).

The processing performed by the repository-use data analysis unit 330 for determination as to whether or not a coincidence occurs can be expressed by, for example, the statements 62 illustrated in FIG. 8. That is, the coincidence-determination information 112 acquired from the application-interface management file 110 is set in “ID” (Get ID From Application-interface Information Management File), and the “ID” is compared with the coincidence-determination information 123 acquired from the application-identifier management file 120. When a noncoincidence is detected by the comparison (If ID≠ID in Application), error processing is performed. When a coincidence is detected by the comparison (Else), the data analysis is performed.

The processing-request data analyzed by the repository-use data analysis unit 330 is passed to the processing request unit 340 (in step S35). Then, the processing request unit 340 transmits the processing-request data 51 to the server 200 (in step S36).

Next, the data analysis performed by using the data analysis program (skeleton) in the server 200 is explained.

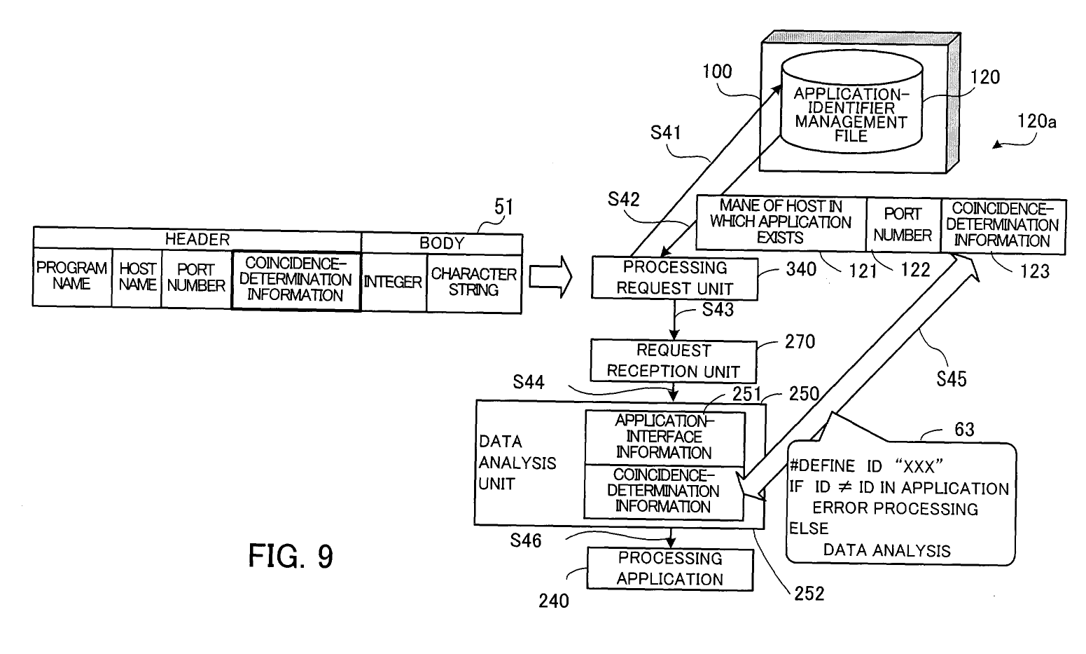

FIG. 9 is a diagram illustrating an example of the data analysis performed by using the data analysis unit in the server 200. When the processing-request application 310 in the client 300 calls the processing application 240 in the server 200, first, the processing request unit 340 in the client 300 accesses the application-identifier management file 120 (in step S41), and acquires the identifier information 120a for the processing application 240 from the application-identifier management file 120 (in step S42). Then, the processing request unit 340 inserts in processing-request data 51 the coincidence-determination information included in the identifier information 120a for the processing application 240, and transfers the processing-request data 51 to the request reception unit 270 in the server 200 (in step S43). The request reception unit 270 passes the processing-request data 51 to the data analysis unit 250 (in step S44).

Further, the data analysis unit 250 compares the coincidence-determination information 252 installed in the data analysis unit 250, with the coincidence-determination information included in the processing-request data 51. When a noncoincidence is detected by the comparison, error processing is performed. When a coincidence is detected by the comparison, the data analysis is started (in step S45).

The processing performed by the data analysis unit 250 for determination as to whether or not a coincidence occurs can be expressed by, for example, the statements 63 illustrated in FIG. 9. That is, the coincidence-determination information installed in the data analysis unit 250 is set in “ID” (#define ID “XXX”), and the “ID” is compared with the coincidence-determination information 123 acquired from the application-identifier management file 120. When a noncoincidence is detected by the comparison (If ID≠ID Application), error processing is performed. When a coincidence is detected by the comparison (Else), the data analysis is performed.

The processing-request data analyzed by the data analysis unit 250 is passed to the processing application 240 (in step S46), and processed by the processing application 240.

Next, the data analysis performed in the server 200 by using the repository (the application-interface management file 110) is explained.

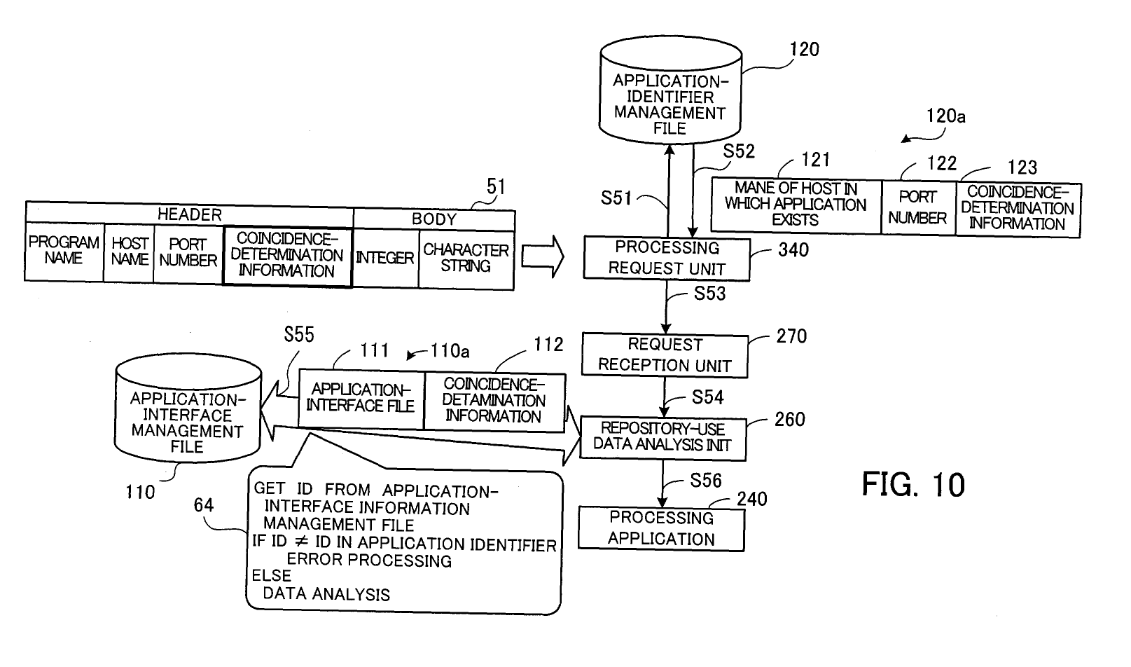

FIG. 10 is a diagram illustrating an example of the data analysis performed in the server 200 by using the repository. When the processing-request application 310 in the client 300 calls the processing application 240 in the server 200, first, the processing request unit 340 in the client 300 accesses the application-identifier management file 120 (in step S51), and acquires the identifier information 120a for the processing application 240 from the application-identifier management file 120 (in step S52). Then, the processing request unit 340 inserts in processing-request data 51 the coincidence-determination information 123 included in the identifier information 120a for the processing application 240, and transfers the processing-request data 51 to the request reception unit 270 in the server 200 (in step S53). The request reception unit 270 passes the processing-request data 51 to the repository-use data analysis unit 260 (in step S54).

Further, the repository-use data analysis unit 260 acquires the coincidence-determination information 112 from the interface management information 110a stored in the application-interface management file 110 for the processing application 240 compares the coincidence-determination information 112 with the coincidence-determination information included in the processing-request data 51. When a noncoincidence is detected by the comparison, error processing is performed. When a coincidence is detected by the comparison, the data analysis is started (in step S55).

The processing performed by the repository-use data analysis unit 260 for determination as to whether or not a coincidence occurs can be expressed by, for example, the statements 64 illustrated in FIG. 10. That is, the coincidence-determination information 112 acquired from the application-interface management file 110 is set in “ID” (Get ID From Application-interface Information Management File), and the “ID” is compared with the coincidence-determination information 123 acquired from the application-identifier management file 120. When a noncoincidence is detected by the comparison (If ID≠ID in Application), error processing is performed. When a coincidence is detected by the comparison (Else), the data analysis is performed.

The analyzed data is passed to the processing application 240 (in step S56), and processed by the processing application 240.

As explained above, in the embodiment of the present invention, it is possible to detect a mismatch in the interface of the application between the client 300 and the server 200. Therefore, it is possible to prevent an abend of a client application or a server application even when an interface of an application existing in a system of another company is changed without any notification or when a request is sent from a client application by using old interface information. Thus, a reliable client-server type system can be realized.

In addition, since the coincidence-determination information used as a reference in comparison for determining whether or not a coincidence occurs is managed in the application-identifier management file 120 in the data-association-information management server 100, clients or servers in each of which a data analysis program is installed can be easily found by monitoring access requests to the application-identifier management file 120. At this time, when an attempt at unauthorized use of the data analysis program is found, it is possible to prevent the unauthorized use by rejecting access to the application-identifier management file 120 from a client or the like in which the data analysis program is installed.

The above processing functions can be realized by server computers and client computers. In this case, server programs and a client program are provided, where the server programs respectively describe details of processing for realizing the functions which the data-association-information management server 100 and the server 200 should have, and the client program describes details of processing for realizing the functions which the client 300 should have. When a server computer executes one of the server programs, the processing functions of the data-association-information management server 100 or the server 200 are realized on the server computer. In addition, when a client computer executes the client program, the processing functions of the client 300 are realized on the client computer.

The server programs and the client program describing the details of the processing can be stored in recording mediums which can be read by the server computers and the client computers. The recording mediums may be magnetic recording devices, optical disks, optical magnetic recording mediums, semiconductor memories, and the like. The magnetic recording devices may be hard disk drives (HDDs), flexible disks (FDs), magnetic tapes, and the like. The optical disks may be DVDs (Digital Versatile Disks), DVD-RAMs (Random Access Memories), CD-ROMs (Compact Disk Read Only Memories), CDs-R (Recordable)/RW (ReWritable), and the like. The optical magnetic recording mediums may be MOs (Magneto-Optical Disks) and the like.

In order to put the server programs and the client program into the market, for example, it is possible to sell a portable recording medium such as a DVD or a CD-ROM in which each of the server programs and the client program is recorded.

Further, it is possible to store the client program in a storage device belonging to a server computer which is connected to a network, and transfer the client program to each client computer connected to the network.

Each server computer which executes one of the server programs stores the one of the server programs in a storage device belonging to the server computer, where the one of the server programs is originally recorded in, for example, a portable recording medium. In this case, the server computer reads the one of the server programs from the storage device, and performs processing in accordance with the one of the server programs. Alternatively, the server computer may directly read the one of the server programs from the portable recording medium for performing processing in accordance with the server program.

Each client computer which executes the client programs stores the client program in a storage device belonging to the client computer, where the client program is originally recorded in, for example, a portable recording medium. In this case, the client computer reads the client program from the storage device, and performs processing in accordance with the client program. Alternatively, the client computer may directly read the client program from the portable recording medium for performing processing in accordance with the client program. Further, the client computer can sequentially execute processing in accordance with each portion of the client program every time the portion of the client program is transferred from a server computer.

As explained above, according to the present invention, only when a coincidence occurs between identification information acquired through a network and identification information associated with a predefined data structure, processing-request data having the predefined data structure is generated, and analyzed after reception. Therefore, even when a data structure of an interface is changed, it is possible to detect at an early stage a computer using an interface which has not yet been changed, and prevent occurrence of an unexpected event.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A client-side data analysis program being executed by a computer for performing communication by data having a unified structure between applications connected through a network, and making said computer perform a sequence of processing which comprises the steps of:
(a) acquiring through a network first identification information associated with a processing application to which a processing request is to be outputted;
(b) comparing said first identification information with second identification information held in association with a predefined data structure; and
(c) generating data of the processing request having said predefined data structure, and transmitting the data of the processing request to a server in which said processing application is installed, when a result of comparison obtained in step (b) indicates that said first identification information coincides with second identification information.

2. The client-side data analysis program according to claim 1, wherein said predefined data structure and said second identification information are defined in descriptions of a program for generating said data of the processing request.

3. The client-side data analysis program according to claim 1, wherein said predefined data structure and said second identification information are defined in an application-interface management file arranged at a predetermined location.

4. The client-side data analysis program according to claim 1, wherein said first identification information is inserted in said data of the processing request.

5. A server-side data analysis program being executed by a computer for performing communication by data having a unified structure between applications connected through a network, and making said computer perform a sequence of processing which comprises the steps of:
(a) acquiring first identification information contained in data of a processing request, when the data of the processing request is received from a client;
(b) comparing said first identification information with second identification information held in association with a predefined data structure; and
(c) analyzing a data structure of said data of the processing request based on said predefined data structure when a result of comparison obtained in step (b) indicates that said first identification information coincides with second identification information.

6. The server-side data analysis program according to claim 5, wherein said predefined data structure and said second identification information are defined in descriptions of a program for generating said data of the processing request.

7. The server-side data analysis program according to claim 5, wherein said predefined data structure and said second identification information are defined in an application-interface management file arranged at a predetermined location.

8. An associated-communication-interface generation program executed by a computer for generating an associated-communication interface which performs communication by data having a unified structure between applications connected through a network, said associated-communication-interface generation program makes said computer perform a sequence of processing which comprises the steps of:
(a) generating, based on interface information in which a data structure of transferred data is defined, a data analysis program for performing data analysis in accordance with said data structure so that said data analysis program includes identification information based on which said interface information can be uniquely identified; and
(b) registering said identification information in an application-identifier management file arranged at a predetermined location on said network.

9. A method for analyzing data in a client so as to perform communication by data having a unified structure between applications connected through a network, comprising the steps of:
(a) acquiring through a network first identification information associated with a processing application to which a processing request is to be outputted;
(b) comparing said first identification information with second identification information held in association with a predefined data structure; and
(c) generating data of the processing request having said predefined data structure, and transmitting the data of the processing request to a server in which said processing application is installed, when a result of comparison obtained in step (b) indicates that said first identification information coincides with second identification information.

10. A method for analyzing data in a server so as to perform communication by data having a unified structure between applications connected through a network, comprising the steps of:
(a) acquiring first identification information contained in data of a processing request, when the data of the processing request is received from a client;
(b) comparing said first identification information with second identification information held in association with a predefined data structure; and
(c) analyzing a data structure of said data of the processing request based on said predefined data structure when a result of comparison obtained in step (b) indicates that said first identification information coincides with second identification information.

11. A method for generating an associated-communication interface which performs communication by data having a unified structure between applications connected through a network, comprising the steps of:
(a) generating, based on interface information in which a data structure of transferred data is defined, a data analysis program for performing data analysis in accordance with said data structure so that said data analysis program includes identification information based on which said interface information can be uniquely identified; and
(b) registering said identification information in an application-identifier management file arranged at a predetermined location on said network.

12. A client apparatus for analyzing data in a client so as to perform communication by data having a unified structure between applications connected through a network, comprising:
acquisition means which acquires through a network first identification information associated with a processing application to which a processing request is to be outputted;
comparison means which compares said first identification information with second identification information held in association with a predefined data structure; and
transmission means which generates data of the processing request having said predefined data structure, and transmits the data of the processing request to a server in which said processing application is installed, when a result of comparison by said comparison means indicates that said first identification information coincides with second identification information.

13. A server apparatus for analyzing data in a server so as to perform communication by data having a unified structure between applications connected through a network, comprising:
acquisition means which acquires first identification information contained in data of a processing request, when the data of the processing request is received from a client;
comparison means which compares said first identification information with second identification information held in association with a predefined data structure; and
analysis means which analyzes a data structure of said data of the processing request based on said predefined data structure when a result of comparison by said comparison means indicates that said first identification information coincides with second identification information.

14. An associated-communication-interface generation apparatus for generating an associated-communication interface which performs communication by data having a unified structure between applications connected through a network, comprising:
data-analysis-program generation means which generates, based on interface information in which a data structure of transferred data is defined, a data analysis program for performing data analysis in accordance with said data structure so that said data analysis program includes identification information based on which said interface information can be uniquely identified; and
identification-information registration means which registers said identification information in an application-identifier management file arranged at a predetermined location on said network.
